(19) United States
(12) Patent Application Publication
(10) Pub. No.: US 2016/0105349 A1
(43) Pub. Date: Apr. 14, 2016

(54) NETWORK DEVICE AND METHOD FOR CHANNEL QUALITY ESTIMATION

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: CHENG-FA ZHU, Shenzhen (CN)

(21) Appl. No.: 14/862,718

(22) Filed: Sep. 23, 2015

(30) Foreign Application Priority Data
Oct. 14, 2014 (CN) 201410542852.3

(51) Int. Cl. H04L 12/26; H04W 4/00; H04W 24/02

(52) U.S. Cl. CPC H04L 43/12; H04W 24/02; H04W 4/008

(57) ABSTRACT

A method for channel quality estimation is executable by a network device. The network device divides channels into a plurality of groups according to a number of channels available in a competing network environment in which the first network device is located, and selects a representative channel from each of the plurality of groups which is central to the frequencies of each available competing channel. The selected representative channels are each tested and each of the channel quality estimations is taken as channel quality estimation of all channels of a group, to save time in estimating and increase efficiency.

### FIELD

The subject matter herein generally relates to wireless communications.

### BACKGROUND

BLUETOOTH communication is widely applied for wireless communications. Like wireless fidelity (WI-FI) communication, BLUETOOTH uses frequency-hopping technology. WI-FI communication usually transmits high-power signals in one or more particular channels, and the BLUETOOTH communication may therefore be affected by the WI-FI communication when both the BLUETOOTH communication and the WI-FI communication are used in a single area. For BLUETOOTH communication to be optimal, channel quality should be assessed and a best channel selected for avoiding WI-FI interference. There are 79 channels in BLUETOOTH protocol, traditional methods for applying channel quality estimations to all of the 79 channels takes a long time and reduces efficiency.

### BRIEF DESCRIPTION OF THE DRAWINGS

Implementations of the present technology will now be described, by way of example only, with reference to the attached figures, wherein:

FIG. 1 is an operating environment of one embodiment of a network device, in accordance with the disclosure;

FIG. 2 is a block diagram of one embodiment of function modules of the network device of FIG. 1, in accordance with the disclosure;

FIG. 3 is a block diagram of one embodiment of another network device;

FIG. 4 is a schematic view of one embodiment of a division of channels by a dividing module, in accordance with the disclosure;

FIG. 5 is a flowchart of one embodiment of a method for channel quality estimation, in accordance with the disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

It should be noted that references to “an” or “one” embodiment in this disclosure are not necessarily to the same embodiment, and such references mean “at least one.”

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series and the like.

Embodiments of a network device and a method for channel quality estimation, are in the following description.

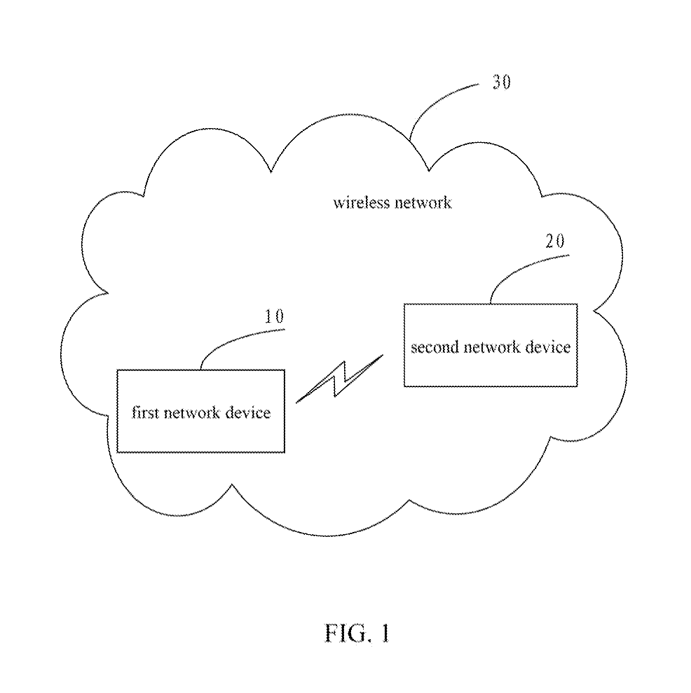

FIG. 1 illustrates an operating environment of one embodiment of a network device. Forming their own network (not shown), a first network device 10 may communicate with a second network device 20 through a plurality of channels. Both the first network device 10 and the second network device 20 are inside a coverage area of a wireless network 30. In the illustrated embodiment, the wireless network 30 may comprise wireless fidelity (WI-FI) or ZIGBEE network. The first network device 10 and the second network device 20 may comprise smart phones, personal computers, or other electronic equipment, and the first network device 10 can communicate with the second network device 20 through BLUETOOTH protocol, but the disclosure is not limited thereto. When the first network device 10 communicates with the second network device 20 through BLUETOOTH protocol, the BLUETOOTH communication may be affected by the wireless network 30. In order to avoid interference, the first network device 10 will firstly execute channel quality estimation and then select good-quality channels for communication.

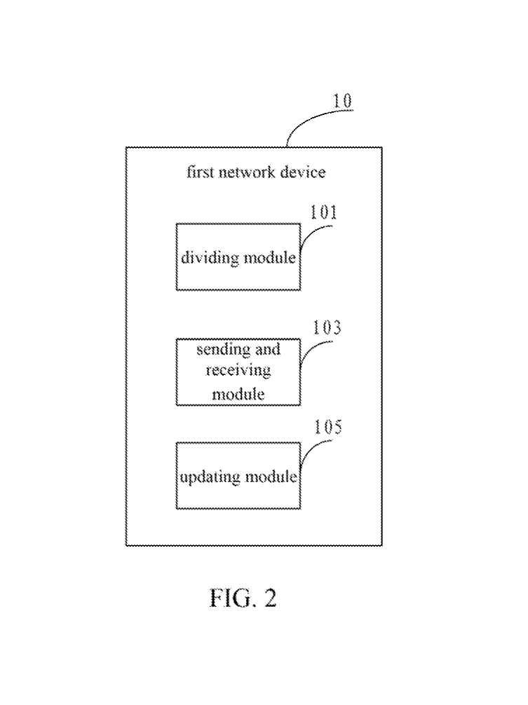

FIG. 2 illustrates a block diagram of one embodiment of function modules of the network device of FIG. 1. The first network device 10 is a master device that is connected and configured to provide services for the second network device 20. The second network device 20 is a slave device that connects to the first network device 10. In the illustrated embodiment, the first network device 10 comprises a dividing module 101, a sending and receiving module 103, and an updating module 105.

In the illustrated embodiment, the first network device 10 is the master device and the second network device 20 is the slave device. This arrangement is utilized as example to illustrate a possible structure of various network devices, but the disclosure is not limited thereto. A network device also may comprise all of above-described function modules, namely, a single network device may achieve full functionality and be utilized as a master device for connecting to other devices, or be connected to other devices as a slave device.

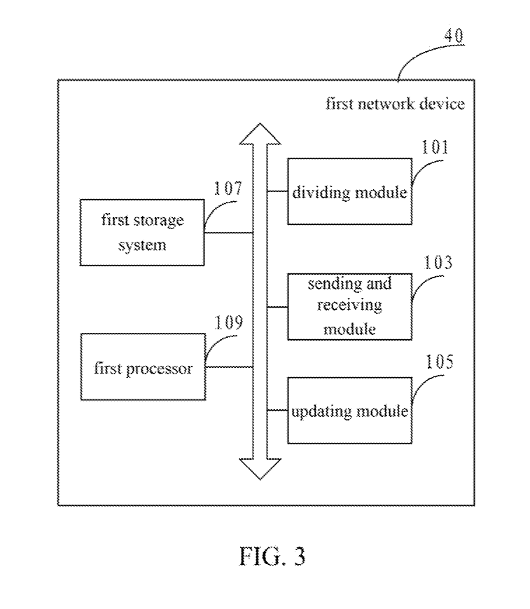

FIG. 3 illustrates a block diagram of one embodiment of another network device. Compared with the network device 10 illustrated by FIG. 1, in the embodiment illustrated by the FIG. 3, a first network device 40 further comprises a first storage system (e.g. a non-transitory storage system) 107 and a first processor 109. Herein, the first processor 109 is configured to execute the functions of the dividing module 101, the sending and receiving module 103, and the updating module 105, to achieve functions of all the modules 103-105 which are stored in the storage system 107.

The embodiment shown in FIG. 2 is an example.

The dividing module 101 divides all the channels into a plurality of groups according to a channel profile of the wireless network 30, and selects a representative channel from each of the plurality of groups, to obtain a plurality of representative channels. In the illustrated embodiment, first, the dividing module 101 divides the channels into a plurality of groups, wherein basis of division is the channel profile of the wireless network 30. In addition, the dividing module 101 further selects a representative channel (hereinafter “SR channel”) from each of the plurality of groups, to obtain a plurality of SR channels. The channel quality of each SR channel will represent channel quality of all channels in a group, estimating the channel qualities of only the SR channels in subsequent process reduces the time for channel quality estimation. In other embodiments, a frequency of each of the plurality of SR channels is equal to a central frequency of a channel of the wireless network 30, which ensures that the estimation of channel quality is more accurate.

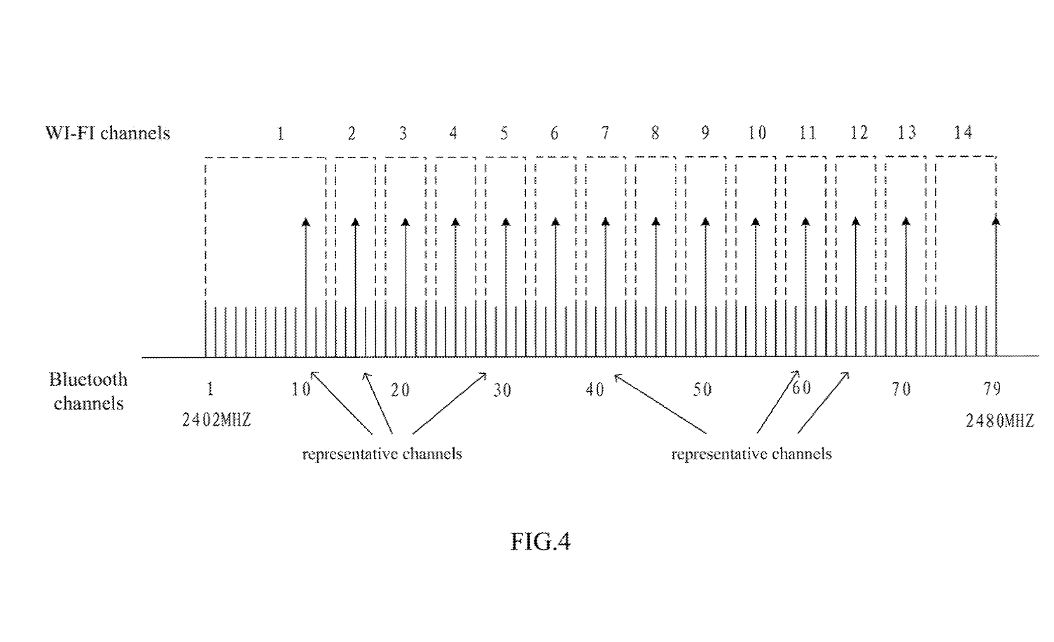

FIG. 4 illustrates an embodiment of division of channels by a dividing module. In the illustrated embodiment, the first network device 10 communicates with the second network device 20 through BLUETOOTH protocol, the wireless network 30 is a WI-FI network. The dividing module 101 divides the 79 BLUETOOTH channels into a plurality of groups. In FIG. 4, each channel profile of BLUETOOTH is indicated by 1-79 (numbers of 1, 10, 20, 30, 40, 50, 60, 70, 79, illustrated in FIG. 4, are utilized to indicate scale labels in the channel profile of the 79 channels), and corresponding BLUETOOTH frequencies are 2402 MHz-2480 MHz. The dividing module 101 may divide these channels by reference to the number of channels in a WI-FI network when the first network device 10 is inside a coverage area of the wireless network 30, the wireless network 30 being a WI-FI network. The WI-FI network works in 14 channels. In FIG. 4, each channel profile of the WI-FI network is indicated by 1-14. The dividing module 101 divides 79 channels into 14 groups according to the channel profile of the WI-FI network, in order that each of the 14 groups can correspond to a channel of the WI-FI network. The 14 groups of the divided channels are as follows: 2402 MHz-2414 MHz, 2415 MHz-2419 MHz, 2420 MHz-2424 MHz, 2425 MHz-2429 MHz, 2430 MHz-2434 MHz, 2435 MHz-2439 MHz, 2440 MHz-2444 MHz, 2445 MHz-2449 MHz, 2450 MHz-2454 MHz, 2455 MHz-2459 MHz, 2460 MHz-2464 MHz, 2465 MHz-2469 MHz, 2470 MHz-2474 MHz, and 2475 MHz-2480 MHz. In addition, the dividing module 101 may select the representative channels (the SR channels) according to central frequencies of the 14 channels of the WI-FI network, each SR channel being equal to a central frequency of a corresponding channel of the WI-FI network. The 14 SR channels are as follows: 2412 MHz, 2417 MHz, 2422 MHz, 2427 MHz, 2432 MHz, 24737 MHz, 2442 MHz, 2447 MHz, 2452 MHz, 2457 MHz, 2462 MHz, 2467 MHz, 2472 MHz, and 2480 MHz.

In other embodiments, the dividing module 101 may divide 79 channels into 16 groups according to a channel profile of a ZIGBEE network, when the wireless network 30 is a ZIGBEE network. The ranges of the 16 groups of divided channels are: 2402 MHz-2407 MHz, 2408 MHz-2412 MHz, 2413 MHz-2417 MHz, 2418 MHz-2422 MHz, 2423 MHz-2427 MHz, 2428 MHz-2432 MHz, 2433 MHz-2437 MHz, 2438 MHz-2442 MHz, 2443 MHz-2447 MHz, 2448 MHz-2452 MHz, 2453 MHz-2457 MHz, 2448 MHz-2462 MHz, 2463 MHz-2467 MHz, 2468 MHz-2472 MHz, 2473 MHz-2477 MHz, and 2478 MHz-2480 MHz. SR channels are selected according to central frequencies of 16 channels of the ZIGBEE network and are as follows: 2405 MHz, 2410 MHz, 2415 MHz, 2420 MHz, 2425 MHz, 2430 MHz, 2435 MHz, 2440 MHz, 2445 MHz, 2450 MHz, 2455 MHz, 2460 MHz, 2465 MHz, 2470 MHz, 2475 MHz, and 2480 MHz.

In other embodiments, the dividing module 101 may divide the channels in other ways, the disclosure is not limited to the way described.

The sending and receiving module 103 can send packets to the second network device 20 through each group of representative channels, and receive channel quality estimations from the second network device 20. In the illustrated embodiment, after the second network device 20 connects to the first network device 10, the first network device 10 sequentially sends packets to the second network device 20 through the SR channels. The second network device 20 receives the packets and analyses the received packets, the second network device 20 can estimate the channel quality from received signal strength or packet loss rate, and finally obtains channel quality estimations of all the SR channels. Then the second network device 20 sends the channel quality estimations to the sending and receiving module 103 of the first network device 10.

The updating module 105 updates a table of channel quality estimations according to the estimations received, each channel quality estimation represents channel quality of all channels of a group. In the illustrated embodiment, after the sending and receiving module 103 of the first network device 10 receives data from the second network device 20, the updating module 105 takes each estimation of the plurality of SR channels as channel quality estimations of all channels of a group. The first network device 10 executes a division and a selection by reference to the network 30 in which the first network device 20 is located, and thus, channel quality of an SR channel can be utilized to represent channel quality of all channels in the group in which the representative channels are located. The updating module 105 takes each of the channel quality estimations as channel quality estimations of all channels in all groups. After obtaining channel quality estimations of all channels, the updating module 105 further updates the table of channel quality estimations, in order to select good-quality channels for communications.

By the above-described embodiment, the first network device 10 divides the channels into a plurality of groups according to a current network environment in which the first network device is located, and selects a representative channel (an SR channel) for each of the plurality of groups. The channel quality estimation of an SR channel is taken as channel quality estimations of all channels in a group in which the representative channel is located, thereby the estimation of quality of the representative channels in this way saves time and increases efficiency.

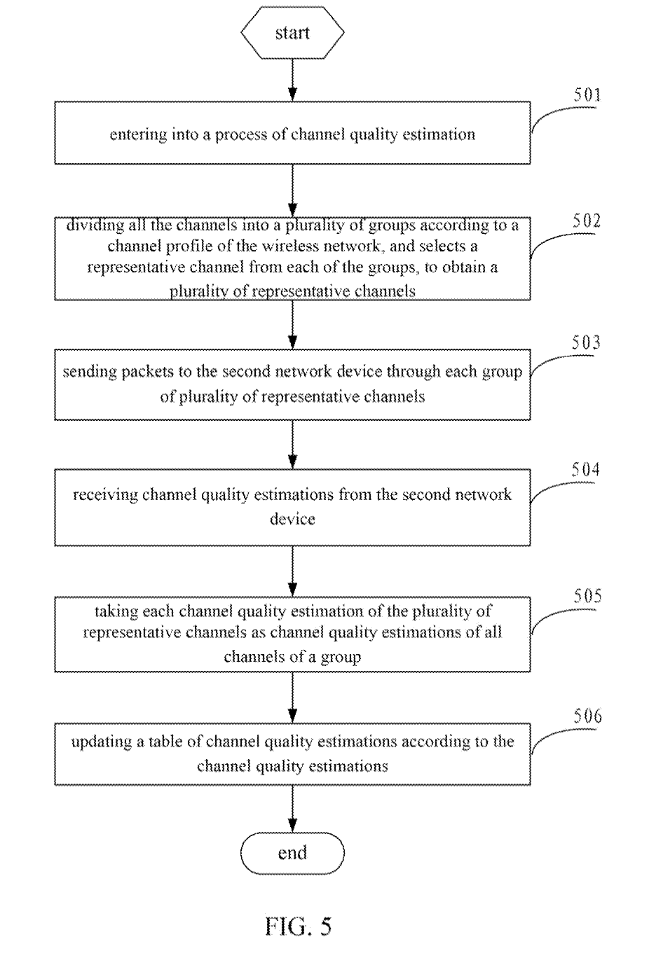

FIG. 5 illustrates a flowchart of one embodiment of a method for channel quality estimation. The method is operable to be executed in a first network device, the first network device wireless communicating with a second network device through a plurality of channels, and where the first network device and the second network device are inside coverage area of a wireless network. In the illustrated embodiment, the method for channel quality estimation may be implemented by function modules of the first network device illustrated in FIG. 3 or FIG. 4, but the disclosure is not limited thereto.

At block 501, the second network device connects to the first network device, the first network device entering into a process of channel quality estimation.

At block 502, the first network device divides all the channels into a plurality of groups according to a channel profile of the wireless network, and selects a representative channel from each of the groups, to obtain a plurality of representative channels. It takes a long time to estimate channel quality for all the channels, so the first network device firstly divides all the channels into a plurality of groups, wherein basis of division is the channel profile of the wireless network. In addition, the first network device further selects a representative channel (hereinafter “SR channel”) from each of the plurality of groups, to obtain a plurality of SR channels. The channel quality of each SR channel will represent channel quality of all channels in a group, estimating the channel qualities of only the SR channels in subsequent process reduces the time for channel quality estimation. In other embodiments, a frequency of each of the plurality of SR channels is equal to a central frequency of a channel of the wireless network, which ensures that the estimation of channel quality is more accurate.

In other embodiments, the first network device may communicate with the second network device through BLUETOOTH protocol, the first network device need divide the 79 BLUETOOTH channels into a plurality of groups.

As a WI-FI network works in 14 channels, the first network device may divide the 79 BLUETOOTH channels into 14 groups by reference to the number of channels in a WI-FI network when the first network device is inside a coverage area of the wireless network. The 14 groups of the divided channels are as follows: 2402 MHz-2414 MHz, 2415 MHz-2419 MHz, 2420 MHz-2424 MHz, 2425 MHz-2429 MHz, 2430 MHz-2434 MHz, 2435 MHz-2439 MHz, 2440 MHz-2444 MHz, 2445 MHz-2449 MHz, 2450 MHz-2454 MHz, 2455 MHz-2459 MHz, 2460 MHz-2464 MHz, 2465 MHz-2469 MHz, 2470 MHz-2474 MHz, and 2475 MHz-2480 MHz. Wherein, the 14 representative channels (the SR channels) are as follows: 2412 MHz, 2417 MHz, 2422 MHz, 2427 MHz, 2432 MHz, 24737 MHz, 2442 MHz, 2447 MHz, 2452 MHz, 2457 MHz, 2462 MHz, 2467 MHz, 2472 MHz, and 2480 MHz.

In other embodiments, the first network device may divide 79 channels into 16 groups according to a channel profile of a ZIGBEE network when the other wireless network is the ZIGBEE network. The ranges of the 16 groups of the divided channels are: 2402 MHz-2407 MHz, 2408 MHz-2412 MHz, 2413 MHz-2417 MHz, 2418 MHz-2422 MHz, 2423 MHz-2427 MHz, 2428 MHz-2432 MHz, 2433 MHz-2437 MHz, 2438 MHz-2442 MHz, 2443 MHz-2447 MHz, 2448 MHz-2452 MHz, 2453 MHz-2457 MHz, 2448 MHz-2462 MHz, 2463 MHz-2467 MHz, 2468 MHz-2472 MHz, 2473 MHz-2477 MHz, and 2478 MHz-2480 MHz. The SR channels are selected according to central frequencies of 16 channels of the ZIGBEE network and are as follows: 2405 MHz, 2410 MHz, 2415 MHz, 2420 MHz, 2425 MHz, 2430 MHz, 2435 MHz, 2440 MHz, 2445 MHz, 2450 MHz, 2455 MHz, 2460 MHz, 2465 MHz, 2470 MHz, 2475 MHz, and 2480 MHz.

In other embodiments, the first network device may divide the channels in other ways, but the disclosure is not limited to the way described.

At block 503, the first network device can send packets to the second network device through each group of representative channels. In at least one embodiment, after the second network device connects to the first network device, the first network device sequentially sends packets to the second network device through the SR channels that are selected by the first network device.

At block 504, the first network device can receive channel quality estimations from the second network device. In the at least one embodiment, the second network device receives the packets and analyses the received packets, the second network device may estimate whether or not channel quality of a representative channel is eligible from received signal strength or packet loss rate, and finally obtains channel quality estimations of all the SR channels. Then the second network device sends the channel quality estimations to the first network device.

At block 505, the first network device takes each channel quality estimation of the plurality of SR channels as channel quality estimations of all channels of a group. In the at least one embodiment, after the first network device receives replies of the second network device, the first network device takes each estimation of the SR channels as channel quality estimations of all channels of a group. Channel quality of an SR channel can be utilized to represent channel quality of all channels of the group in which the SR channel is located, so each estimation of the SR channels can be utilized as channel quality estimations of all channels of a group.

At block 506, the first network device updates a table of channel quality estimations according to the channel quality estimations. In the at least one embodiment, after obtaining channel quality estimations of all the SR channels, the first network device further updates the table of channel quality estimation, in order to select good-quality channels for communications.

By the above-described embodiment of the method, the first network device divides the channels into a plurality of groups according to a current network environment where the first network device is located, and selects a representative channel (an SR channel) for each of the plurality of groups. The channel quality estimation of an SR is taken as channel quality estimations of all channels in a group in which the representative channel is located, thereby the estimation of quality of the representative channels in this way saves time and increases efficiency.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A network device wireless communicating with at least one other network device through a plurality of channels, wherein the network device and the at least one other network device are inside a coverage area of a wireless network, the network device comprising:
at least one processor;
a non-transitory storage system coupled to the at least one processor and configured to store one or more programs configured to be executed by the at least one processor, the one or more programs including instructions for:
dividing the plurality of channels into a plurality of groups according to a channel profile of the wireless network;
selecting a representative channel from each of the plurality of groups, to obtain a plurality of representative channels;
sending packets to the other network device through the plurality of representative channels;
receiving channel quality estimations from the other network device; and
updating a table of channel quality estimations according to the channel quality estimations, wherein each channel quality estimation represents channel quality of all channels of a group.

2. The network device of claim 1, wherein a frequency of each of the plurality of representative channels is equal to a central frequency of a channel of the wireless network.

3. The network device of claim 1, wherein the channels include BLUETOOTH channels.

4. The network device of claim 3, wherein the wireless network includes wireless fidelity (WI-FI) network, and the one or more programs further including instructions for:
dividing the BLUETOOTH channels into 14 groups according to a channel profile of the WI-FI network.

5. The network device of claim 3, wherein the wireless network includes ZIGBEE network, and the one or more programs further include instructions for:
dividing the BLUETOOTH channels into 16 groups according to a channel profile of the ZIGBEE network.

6. A method for channel quality estimation operable to be executed in a network device, the network device wireless communicating with at least one other network device through a plurality of channels, wherein the network device and the at least one other network device are inside a coverage area of a wireless network, the method comprising:
dividing the plurality of channels into a plurality of groups according to a channel profile of the wireless network;
selecting a representative channel from each of the plurality of groups, to obtain a plurality of representative channels;
sending packets to the other network device through the plurality of representative channels;
receiving channel quality estimations from the network device; and
updating a table of channel quality estimations according to the channel quality estimations, wherein each channel quality estimation represents channel quality of all channels of a group.

7. The method of claim 6, wherein a frequency of each of the plurality of representative channels is equal to a central frequency of a channel of the wireless network.

8. The method of claim 6, wherein further comprising: the channels include BLUETOOTH channels.

9. The method of claim 8, wherein the wireless network includes wireless fidelity (WI-FI) network, the dividing the plurality of channels into a plurality of groups according to a channel profile of the wireless network further comprising:
dividing the BLUETOOTH channels into 14 groups according to a channel profile of the WI-FI network.

10. The method of claim 8, wherein the wireless network includes ZIGBEE network, the dividing the plurality of channels into a plurality of groups according to a channel profile of the wireless network further comprising:
dividing the BLUETOOTH channels into 16 groups according to a channel profile of the ZIGBEE network.
